(19) United States
(12) Patent Application Publication
(10) Pub. No.: US 2013/0200079 A1
(43) Pub. Date: Aug. 8, 2013

(54) ABOVE GROUND FLUID STORAGE SYSTEM

(71) Applicants: Gerald D. MANN, Franklinville, NJ (US); Julian P. MASON, Hammonton, NJ (US); Daniel E. DEAVERS, JR., Rowlett, TX (US); John M. RUGGERO, JR., Hammonton, NJ (US); Robert F. GATTA, Slingerlands, NY (US)

(72) Inventors: Gerald D. MANN, Franklinville, NJ (US); Julian P. MASON, Hammonton, NJ (US); Daniel E. DEAVERS, JR., Rowlett, TX (US); John M. RUGGERO, JR., Hammonton, NJ (US); Robert F. GATTA, Slingerlands, NY (US)

(21) Appl. No.: 13/365,924

(22) Filed: Feb. 3, 2012

(51) Int. Cl. B65D 90/02; E02D 19/04; B23P 11/00

(52) U.S. Cl. 220/565; 29/525.11; 405/11

(57) ABSTRACT

An above ground liquid storage system includes a substantially impermeable liner bounding an interior for receiving a liquid. A plurality of supporting structures and a base support the liner and the liquid when the liquid is received in the interior. The liner extends from the base over a top end of the plurality of supporting structures and descends to the ground to form a cavity under the plurality of supporting structures. A first supporting structure of the plurality of supporting structures includes a leg member supporting the liner and a support member connected to the leg member and holding the leg member upright. At least one of the leg member and the support member includes a releasably attachable extension portion to allow separation of the extension portion from a remainder of at least of the leg member and support member.

### CROSS-REFERENCE TO RELATED APPLICATIONS

This application relates to U.S. Application No. 61/474,431 (Attorney Docket No. 3536.001P) filed Apr. 12, 2011, and U.S. application Ser. No. 13/165,118 (Attorney Docket No. 3536.001A) filed Jun. 21, 2011, the entire disclosures of which are incorporated herein by reference.

### TECHNICAL FIELD

This invention relates, in general, to storage systems for holding large quantities of various fluids for use in industrial, commercial and energy applications, and more particularly systems for above ground impoundment of water.

### BACKGROUND ART

Hydraulic Fracturing (i.e., fracking) is a method of extracting natural gas that is trapped in the layers of shale thousands of feet below the surface. The process involves drilling into shale formations (5,000 to 20,000 feet below the surface) and pumping fracturing fluid into the formation at great pressures fracturing the rock creating a conduit for the natural gas to be extracted through. The fracking process requires millions of gallons of water, much of which is extracted from the shale formations and must be stored prior to being treated for any contaminants which they receive during the drilling process. Most “fracking” sites in the Marcellus Shale region located in Pennsylvania, West Virginia, and southern New York are in very remote locations and the pads (drilling sites) have relatively small footprints, thus the storage of massive amounts of water within a small footprint requires a voluminous vessel. Currently there are two methods for large water storage: below ground (lined pit) and above ground (defined storage vessel).

In other examples, water high in turbidity as the result of marine construction must be impounded to allow settling in order to meet environmental permitting regulations or industrial fluids will require temporary impoundments while a permanent impoundment is construction. Additionally, marine construction work can be accomplished in a dry condition through the use of a cofferdam. Cofferdams may be utilized to hold water out of such areas to permit such dry work. Such work could include bridge repair, pipeline installation crossing a waterway, remediation work in such normally wet areas, and inlet or outlet structures for waterways.

Thus, a need exists for improved systems and methods for impounding liquids above ground and as a cofferdam to permit in-water work in a dry condition.

### SUMMARY OF THE INVENTION

The present invention provides, in a first aspect, an above ground liquid storage system which includes a substantially impermeable liner bounding an interior for receiving a liquid. A plurality of supporting structures and a base support the liner and the liquid when the liquid is received in the interior. The liner extends from the base over a top end of the plurality of supporting structures and descends to the ground to form a cavity under the plurality of supporting structures. A first supporting structure of the plurality of supporting structures includes a leg member supporting the liner and a support member connected to the leg member and holding the leg member upright. At least one of the leg member and support member includes a releasably attachable extension portion to allow separation of the extension portion from a remainder of at least one of the leg member and the support member.

The present invention provides, in a second aspect, a method for use in above ground storage of a liquid which includes transporting a plurality of supporting structures from a first location to a set up location. Each supporting structure of the plurality of supporting structures includes a leg member configured to support a support member connected to the leg member and configured to hold the leg member upright. An extension portion of at least one of the leg member and the support member is releasably attached to a remainder of at least one of the leg member and support member. The plurality of supporting structures is connected to one another such that a base is surrounded by the plurality of supporting structures.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention will be readily understood from the following detailed description of preferred embodiments taken in conjunction with the accompanying drawings in which:

FIG. 1 is a cutaway view of a portion of a supporting system supporting a basin in accordance with the present invention;

FIG. 2 is a side cross-sectional view of the basin of FIG. 1;

FIG. 3 is a perspective view of a backside of the supporting system of the basin of FIG. 1;

FIG. 4 is a perspective view of the basin of FIG. 1;

FIG. 5 is a side cross-sectional view of a portion of the basin of FIG. 1 including an air conditioning mechanism and fluid connection means connected to an underside of the basin;

FIG. 6 is a side view of a clamp for connecting the supporting structures of the basin of FIG. 1 to each other;

FIG. 7 is a front view of the clamp of FIG. 6 including a cover in accordance with the present invention;

FIG. 8 is a perspective view of the basin of FIG. 1 including a conduit on a support member allowing fluid flow over a top side of the basin;

FIG. 9 is a side view of a supporting structure of the plurality of supporting structures utilized in a basin as in FIG. 2 in an aspect of the invention;

FIG. 10 is a side cross-sectional, exploded view of a side portion of the supporting structure of FIG. 9 connectable to an extension portion thereof;

FIG. 11 is a front cross-sectional exploded view of the side portion of FIG. 10;

FIG. 12 is a front side cross-sectional view of the side portion of FIG. 11 connected to the extension portion of FIG. 10;

FIG. 13 is another example of a side cross-sectional, exploded view of a side portion of the supporting structure of FIG. 9 connectable to an extension portion thereof; and

FIG. 14 is a side cross-sectional view of the side portion connected to the extension portion of FIG. 13;

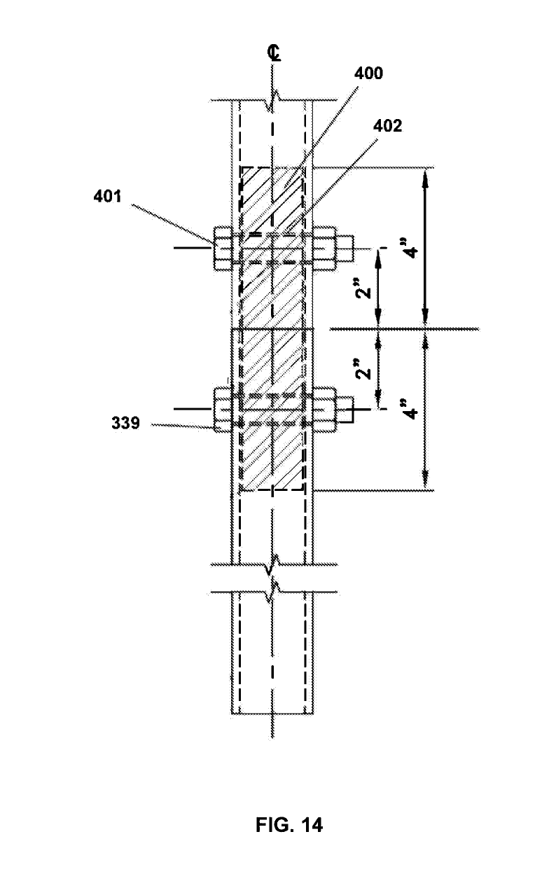

### DETAILED DESCRIPTION

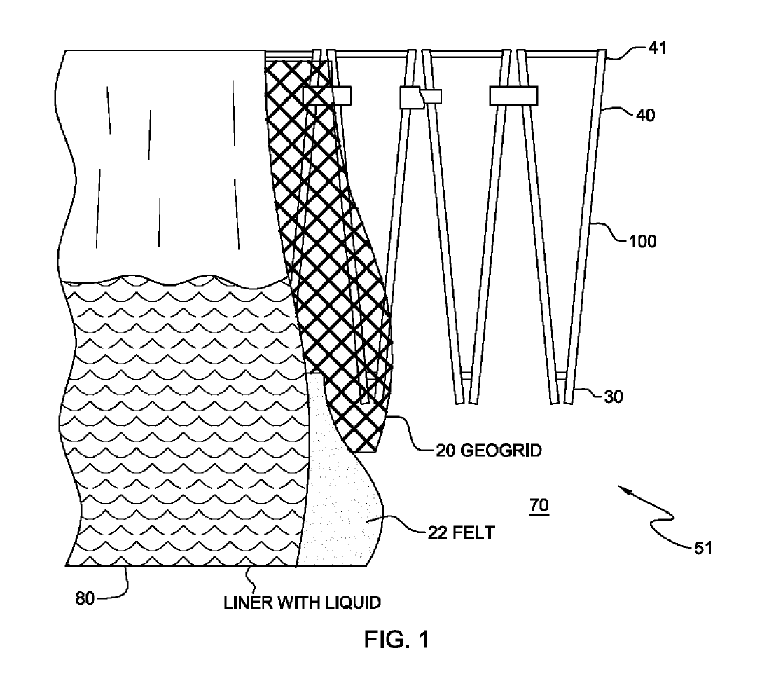

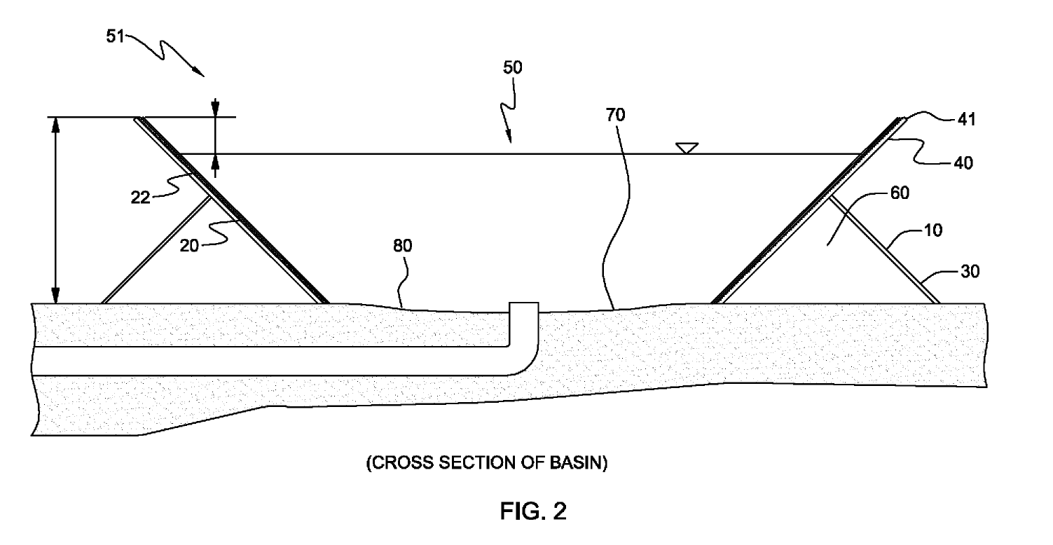

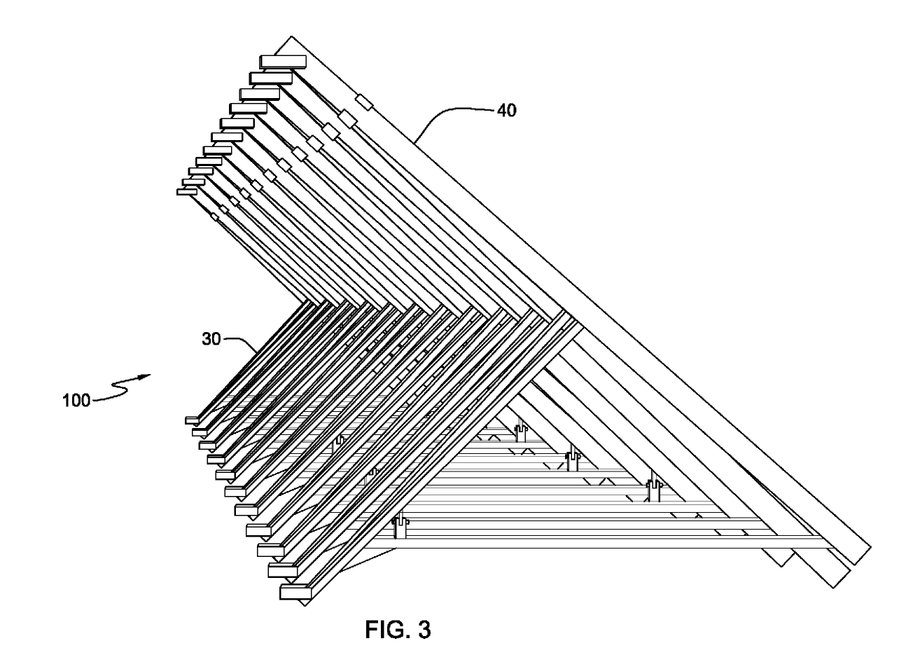

In an exemplary embodiment depicted in FIGS. 1-7 an above ground liquid containment system or basin 51 is shown. Basin 51 may be configured (e.g., shaped and dimensioned) to any shape and various heights. Basin 51 may include a series of interconnected supporting structures or frame units 100 spaced at intervals erected on a prepared surface (e.g., a concrete pad) to form a container skeleton or support structure. Each frame unit includes a support portion 30 and a leg portion 40 facing an interior 50 of the basin. A plurality of leg portions 40 may extend upwardly at an angle (e.g., about 43 degrees) to support basin 51 and any contents of interior 50. The leg portions may be supported by a plurality of support portions 30. The support portions and leg portions may be formed of wood, metal or plastic members fastened to each other and configured to carry the weight of a liquid (e.g., water from a fracturing process) in interior 50 of basin 51. Such support portion and leg portions could also be monolithically formed (e.g., by molding, casting, etc.). As depicted in the figures, such a leg portion (e.g., leg portion 40) may have a linear shape extending from base 70 at an angle less than 90 degrees and more than 30 degrees, for example, while the support portion (e.g., support portion 30) may be formed of a Y shaped structure having a bottom horizontal portion 31 and a side portion 32 extending from leg portion 40 to connect to an end of horizontal portion 31 (i.e., the end away from base 70). A frame cavity 60 (e.g., having a triangular shape) may be formed by the connection of one of support portions 30 to one of leg portions 40. The cavity may be a variety of shapes (e.g., an equilateral triangle) depending on the configuration (e.g., shape and dimension) of the support portions and leg portions.

A thick geogrid material 20 may extend from a top 41 of each leg portion 40 downwardly on the leg portion and continue a short distance out onto a base 70 as depicted in FIG, 1, for example. Geogrid material 20 has the ability to restrict a liner 80 from forming pockets within frame units 100 due to the added rigidity it provides, thus keeping a surface of the liner facing the liquid as a smooth sided container. Geogrid material 20 is attached at intervals to one or more of support portions 30 and/or leg portions 40 of the frame unit with zip ties or other connection mechanism(s). Geo-grid material 20 may be a material configured for use as a base course for reinforcement and soil stabilization such as MARAFI BXG GEOGRID. Such a geo-grid material may have a tensile strength of 2,500 pounds per foot in a machine direction and 2,500 pounds per foot in a cross direction.

Base 70 (i.e., horizontal portion surrounded by the frame units) of basin 51 may be a portion of a concrete pad or other material capable of supporting the weight of liquid thereon in conjunction with the frames (e.g., frames 100) which surround such base. Further, basin 51 may be lined with a thick felt material 22 which overlaps geogrid material 20 a short distance and is attached to one or more of support portions 30 and/or leg portions 40 by means of zip ties or other connection mechanism(s). For example, the felt may be a needle punched non-woven geo-textile composed of polypropylene fibers formed with a stable network such that the fibers retain their relative position, such as MIRAFI 180N. Such a geo-textile may be inert to biological degradation and resist naturally encountered chemicals, alkalis and acids. The felt material 20 may have a weight of 271 grams per meter squared and a thickness of 1.8 mm, for example.

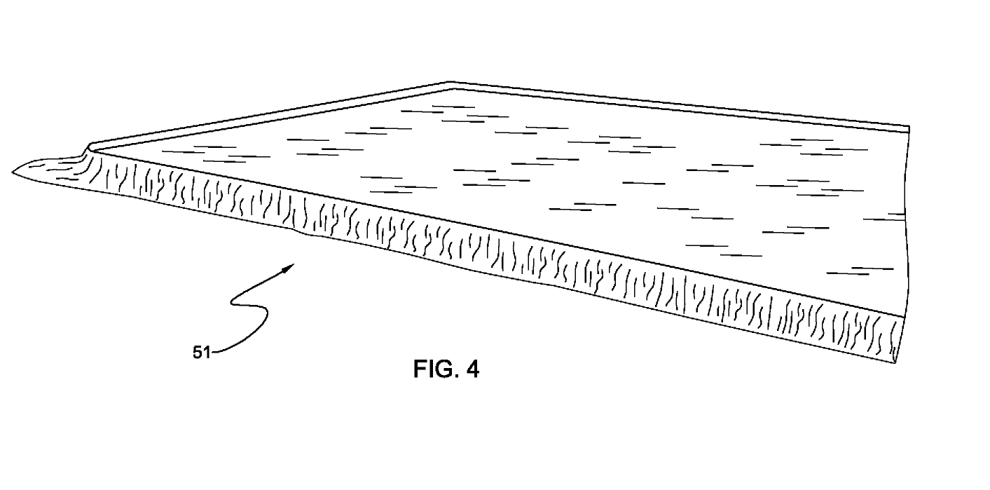

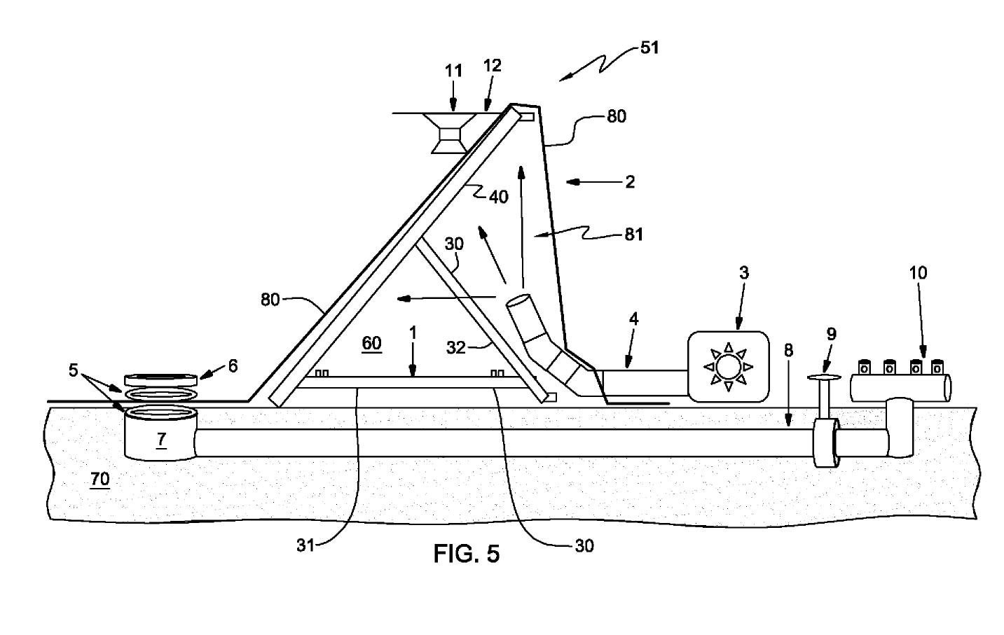

Liner 80 may be a continuous liner impermeable to liquids (e.g., water) installed on the container skeleton (i.e., frame units 100, geogrid material 20, base 70). Liner 80 may be tailored (e.g., shaped and dimensioned) to fit the inside measurements of basin 51 (e.g., the inside surface of the plurality of leg portions 40 and base 70) and extend over the top (e.g., top 41) of frame units 100 and vertically down to the ground on the outside of the container, where it may be anchored to the ground by weight. FIGS. 4 and 5 depict the liner pulled over the frame to the ground. Further, the liner may be any type of liner which may support the weight of water or another liquid when connected to frame units 100 and may be substantially impermeable. Also, liner 80 may be formed of a plurality of liner portions welded or otherwise connected to one another such that the seams are substantially impermeable. Further, liner 80 could be formed of a scrim reinforced polyethylene, such as DUR SKRIM. Such a liner could have an average thickness of about 30 mil, a weight of about 144 pounds per thousand square feet. The liner may also have a tensile strength of 160 foot pounds per square inch in a machine direction and 150 foot pounds per square inch in a transverse direction. The liner may be a reinforced laminate manufactured using high strength virgin grade polyethylene resins and stabilizers.

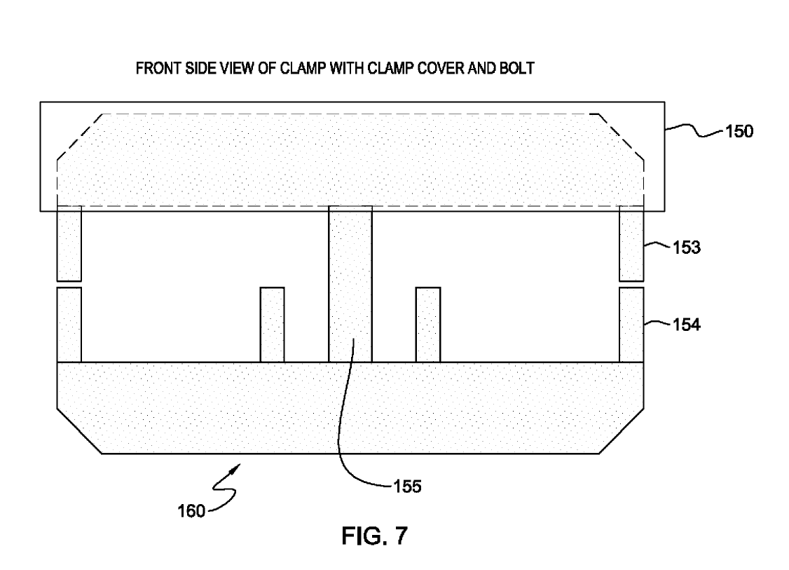

When liner 80 extends from top 41 to the ground, a liner cavity or area 81 under liner 80 and under leg portions 40, including cavities 60, may be heated, cooled or otherwise conditioned. For example, warmed air may be pumped into area 81 to maintain the area under leg portions 40 at a desired temperature such that any liquid held in interior 50 is held at a desired temperature due to the convection and conduction occurring in the area under leg portions 40 relative to leg portions 40, geogrid 20, any felt and liner 80. For example, area 81 under leg portions and under liner 80 (e.g., including cavities 60) may be heated (e.g., a heater 3 may be connected to a tube 4 to provide heated air as depicted in FIG. 7) to avoid any liquid in interior 50 from freezing thereby avoiding any damage that could occur to liner 80 resulting from freezing and/or thawing of the liquid. Also, a bubbling mechanism 11 may be utilized to inhibit freezing of the liquid in basin 50 to minimize any such damage to liner 80 as depicted in FIG. 7. Such a bubbling mechanism could be any type of air generating mechanism which provides air to a liquid held in interior 50 to inhibit freezing of the liquid and thereby avoid any damage to basin 51, including liner 80, due to such freezing.

Basin 51 could also be configured to include under-floor or over-top piping to accommodate inflow/outflow requirements into and/or out of interior 50. Over the top piping may be utilized where under-floor piping is not feasible, for example. Basin 51 could also be configured to allow the liquid/slurry to weir over in a particular location at a desired elevation. As depicted in FIG. 5, a drain/inlet may be provided in base 70 and liner 80 to allow fluid communication therethrough. As depicted in the figures, fluid communication may be provided through an underside (e.g., base 70) of basin 51. A manhole casting 5 may connect to an underside of basin 51 opposite interior 50 and seals 6 may be utilized on opposite sides of liner 80. A manhole riser 7 may be coupled to casting 5 and the seals. A conduit 8 may connect riser 7 to a manifold system 10 to allow the introduction and/or removal of liquids relative to interior 50 therethrough. A shutoff valve 9 may be utilized to allow or prevent such fluid communication.

In one example, manhole casting 5 may be 6″ to 8″ in height. The drain may be 24″ in diameter on top (for the opening) and then 36″ at the base which is between 5′ and 7′ below the top surface of the drain. These dimensions may be adjusted as desired, e.g., to adjust an amount of flow to fill and discharge the system.

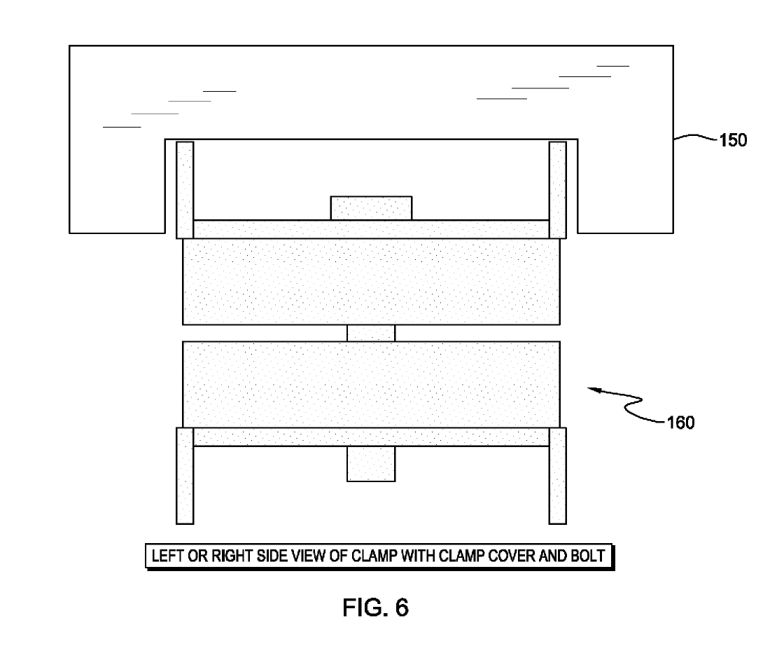

As depicted in FIGS. 6 and 7, a clamp cover 150 may protect the liner material (i.e., liner 80) from a clamp. The cover may be formed of a foam material (e.g., 1.7# low density form fit polyethylene foam or any other material which would properly act as a cushion/buffer to minimize risk of damage from impact, chaffing, puncturing or tearing) which fits over a clamp 160 which then rests against the geogrid material (e.g., geogrid material 20), which contacts the liner material. The cover may be connected to the clamp by twine or zip ties, for example. Multiple clamps 160 may be utilized to connect individual frame units (e.g., units 100) to each other as depicted in the figures. For example, a top portion 153 and a bottom portion 154 may receive multiple leg portions 40 therebetween to connect such leg portions to one another. The top portion and bottom portion could be connected to each other by a fastening mechanism, such as a bolt 155, for example. Clamp 160 could be shaped and dimensioned in any way to allow adjacent frame units 100 (e.g., leg portions 40 thereof) to be connected to one another.

Further, basin 51 may include a portion thereof having a top end lower than a remaining portion of such basin. For example, several of frame units 100 may include leg portion 40 of reduced length such that a top end in the local area of such reduced dimensioned leg portions are lower than the top ends of other leg portions adjacent such reduced dimension leg portions. This reduced height may form a weir to allow liquid in interior 50 to flow out of basin 51 when such liquid reaches a top end of the reduced height portion. Such a “weir over” arrangement may be useful in the case of the subsurface conditions don't allow for an underground method or when such an underground method is not cost effective.

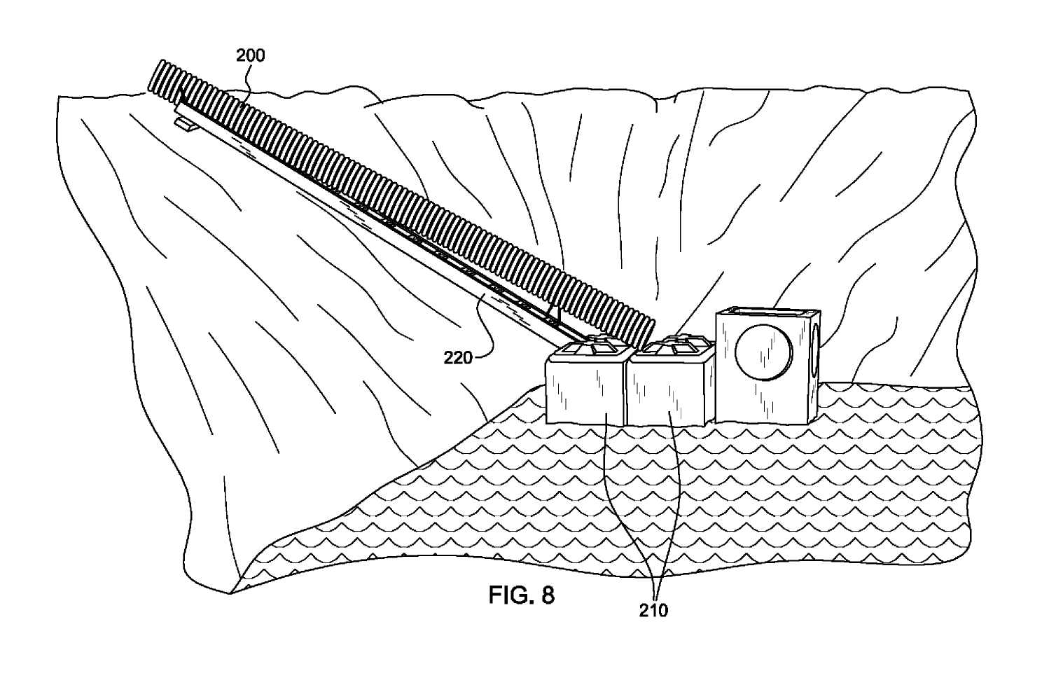

In another example, basin 51 may include a conduit 200 which extends from liner 80 in the vicinity of top end 41 into interior 50 and rests on a supporting surface, such as concrete blocks 210, as depicted in FIG. 8. Such blocks may act as an anchoring point for the conduit and also may act as a diffusion device when fluid flows at high velocity through conduit 200. Liquid may flow into and/or out of basin 51 through conduit 200 (e.g., via pump(s)). A support 220 may extend from one of blocks 210 to a position at/or near top end 41 to support conduit 200 as depicted in FIG. 8.

Further, in another example, through-wall piping for filling/evacuating fluid materials may be used when sub-surface conditions don't permit installation of an in-floor system (e.g., conduit 8) or an over-the-top system cannot be properly stabilized (e.g., secured to dead-men inside basin) to minimize the risk of liner damage by pipe thrashing. Such a through-wall piping system would extend through leg 40, liner 80, and geo-grid 20, for example, such that a conduit extending through leg 40, and liner 80 is sealed to inhibit leakage through liner 80 and leg 40 other than that flowing through such conduit.

Supporting structures 100 and the other components of basin 51 may also be configured (e.g., shaped and dimensioned) as a cofferdam system to divert water from a particular location to allow dry work or otherwise maintain water on an opposite side of such basin or cofferdam relative such desired dry area.

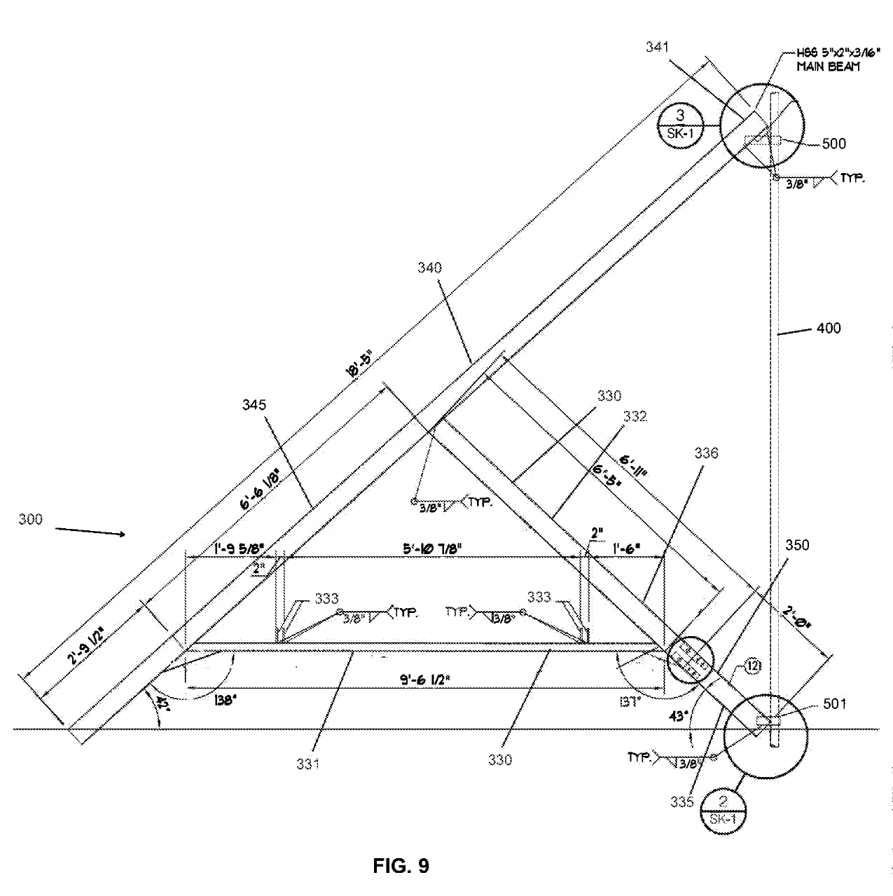

In a further example depicted in FIGS. 9-13, supporting structures 100 may be replaced by supporting structures 300 in basin 51 with the remaining components of basin 51 described above remaining. Supporting structures 300 may each include a support portion 330 and a leg portion 340 having an interior surface 345 facing an interior 50 of the basin as described above. A plurality of leg portions 340 may extend upwardly at an angle (e.g., about 43 degrees) to support basin 51 and any contents of interior 50. The leg portions may be supported by a plurality of support portions 330. The support portions and leg portions may be formed of wood, metal or plastic members fastened to each other and configured to carry the weight of a liquid (e.g., water from a fracturing process) in interior 50 of basin 51. Such support portion and leg portions could also be monolithically formed (e.g., by molding, casting, etc.). As depicted in the figures, such a leg portion (e.g., leg portion 340) may have a linear shape extending from base 70 at an angle less than 90 degrees and more than 30 degrees, for example, while the support portion (e.g., support portion 330) may be formed of “Y”) shaped structure having a bottom horizontal portion 331 and a side portion 332 extending from leg portion 340 to connect to an end of horizontal portion 331 (i.e., the end away from base 70) and further away from leg portion 340 to contact a surface (e.g., the ground) to allow supporting structure 300 to support leg portion 340. Side portion 332 may include an extension portion 350 which may be removably attachable to a remainder 336 of side portion 332 via any of various removable attaching fasteners including bolts, screws, temporary welds, friction fits, etc.

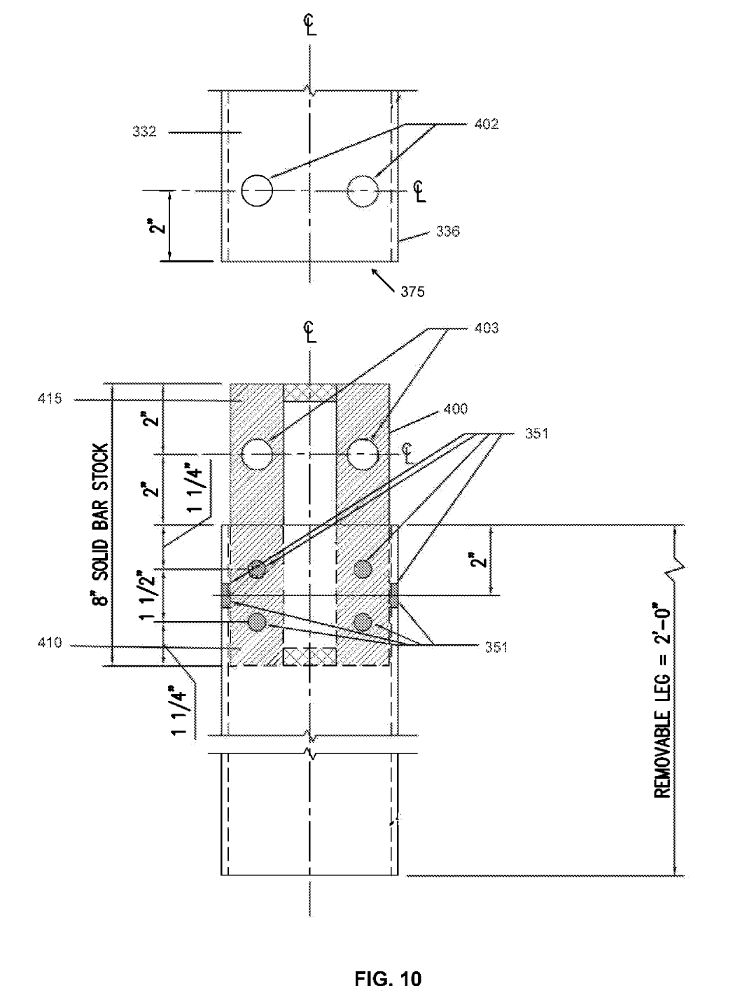

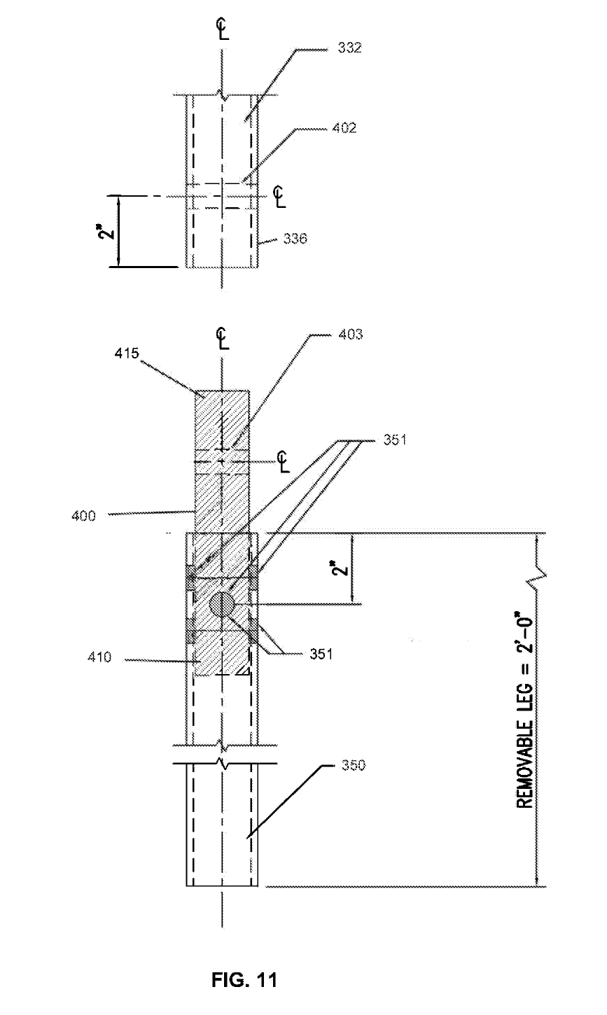

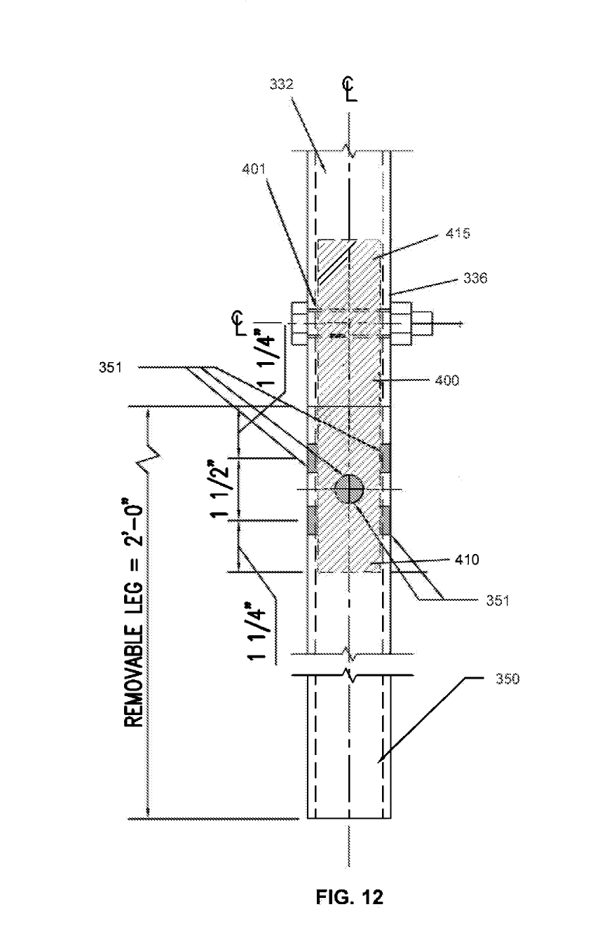

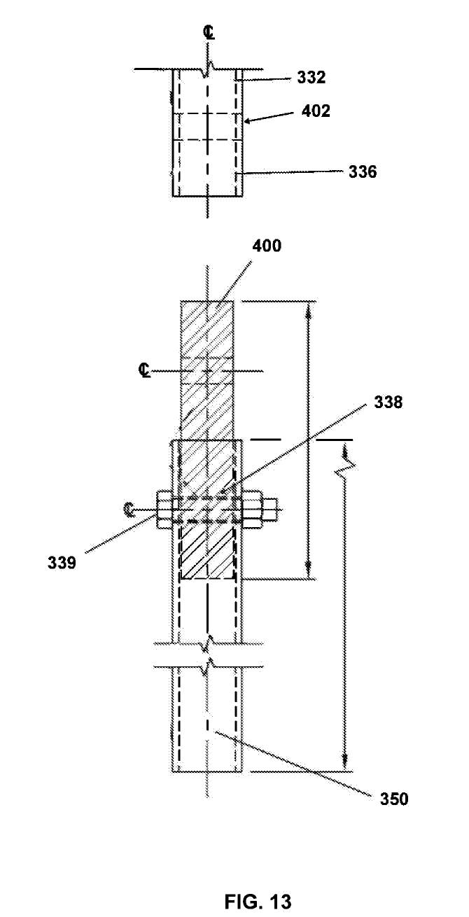

As depicted in FIGS. 10-11, a connecting bridge portion 400 may be connectable (e.g., releasably) to both remainder 336 and extension portion 350 to provide a connection therebetween. Bridge portion 400 may have an outside dimension (e.g., width or diameter in a direction perpendicular to a longitudinal dimension thereof) that is smaller than an inside dimension (e.g., perimeter or diameter) of extension portion 350 to allow a first end 410 of bridge portion 400 to be received in a cavity 360 of extension 350. As depicted in FIGS. 10-11, extension portion 350 may include one or more (e.g., 10) openings 351 to facilitate (e.g. temporary) plug welding of extension portion 350 to first end 410. Also, a second end 415 of bridge portion 400 may have an outside dimension (e.g., perimeter or diameter in a direction perpendicular to a longitudinal dimension thereof) that is smaller than an inside dimension (e.g., perimeter or diameter) of remainder 336 to allow second end 415 to be received in a cavity 375 of remainder 336 as depicted in FIG. 11. As also depicted in FIG. 11, extension 350 may be connected to bridge portion 400 by plug welding while remainder 336 may be connected to bridge portion 400 by bolts 401 inserted in openings 403 of bridge portion 400 and openings 402 of remainder 336, or another releasable mechanical fastener. Also, in another example depicted in FIGS. 12-13, extension portion 350 and end 335 may both include holes 338 to allow bolts 339 to pass therethrough to allow the removable attachment of extension portion 350 and end 335 to bridge portion 350 by such bolts or other mechanical fasteners.

Further, a pole 400 may be attached to a top end 341 of leg portion 340 and a bottom end 352 of extension portion 350 (e.g., by a flat metal bar 500 or 501 connected to both) to provide additional support (e.g., vertically) when the components of basin 51 are installed in less than ideal conditions, e.g., when configured as a cofferdam and located in muddy and/or unstable locations. Also, horizontal portion 331 may include upwardly extending portions 333 configured to connect to connecting bars (e.g., steel bars) configured to connect an adjacent horizontal portion of an adjacent supporting structure such that multiple (e.g., pairs) of such supporting structures may be connected to one another. Further, top ends 341 of such supporting structures could also be connected to one another (e.g., via steel bars) for such additional structural support.

Extension portion 350 may be sized (e.g. shaped and dimensioned) to allow supporting structures 300 to be transported by a vehicle, (e.g., truck, train, etc.) when extension portions 350 of each supporting structure of the supporting structures are not connected to a remainder (e.g., remainder 336) of each of side portions 332 of the supporting structures. More specifically, in one example, supporting structures 330 may be arranged on a flat bed of a truck such that interior surface 345 of leg portion 340 lays flat and contacts the bed of the truck. Side portion 332 may extend upwardly (e.g., substantially perpendicularly to the longitudinal dimension of leg portion 340) and may be dimensioned (e.g., 6 foot 11 inches) such that end 335 does not exceed an acceptable height for road transportation given the standard height of bridges and standard transportation permits in the U.S. The releasable attachment of extension portion 350 to side portion 332 allows basin 51 to be constructed on site (e.g., at a hydrofracking site or a marine construction site) at a desired size (e.g., such that side portion 332 has a desired height when extension portion 350 is connected to remainder 336 of side portion 332) without shipping height being a limitation as to which supporting structures may be used and thus the size of the basin to be constructed. In one example, extension portion 350 may be 2 feet long while remainder 336 of side portion 332 may be 6 feet 11 inches long and horizontal portion 31 may be 9 feet 6½ inches long. Leg portion 340 may be 18 feet 5 inches long, and leg portion 340, extension portion 350 and remainder 336 may all be formed of HSS (hollow structural section) steel of 5″×2″× 3/16″. Also, bridge portion 400 may be a solid metal bar having a length of about 8 inches with a cross-sectional dimension less than an internal dimension of extension portion 350 and remainder 336.

In another example, (not depicted) which does not utilize a bridge portion connecting remainder 336 and extension portion 350, end 335 of side portion 332 may have an outside dimension (e.g., perimeter or diameter in a direction perpendicular to a longitudinal dimension thereof) that is smaller than an inside dimension (e.g., perimeter or diameter) of extension portion 350 to allow end 335 to be received in cavity 360 of extension 350. Extension portion 350 may include one or more (e.g., three) openings 351 to facilitate (e.g. temporary) plug welding of extension portion 350 to end 335. Extension portion 350 and end 335 may both include holes to allow bolts to pass therethrough to allow the removable attachment of extension portion 350 to end 335 by such bolts or other mechanical fasteners. In another example, end 335 and extension 350 may be configured (e.g., shaped and dimensioned) to allow extension 350 to be received in a cavity of end 335 instead of end 335 being received in extension 350 as described above. The fasteners used to connect (e.g., releasably) the end and extension may be the same as those described above for the end and extension. Further, the portion of extension portion 350 which may extend into end 335 or the portion of end 335 which may extend into the cavity of extension 350 may be about 8 inches and may be additional to the lengths described above relative to the end and extension.

In a further example, a basin or cofferdam (e.g., basin 51) may include a plurality of leg portions each of (e.g. leg portion 340) which has a removable extension portion, such as disclosed above relative to extension portions 350 connectible to remainder 336 of side portion 332. The use of such extension portion releasably attachable to a remainder of the leg portion may allow for a variable height of supporting structures (e.g., supporting structure 300) to facilitate transportation thereof and maintain a height of such supporting structures at a desired dimension where such supporting structures are transported on a vehicle (e.g., truck or train). In one example, a top end of such supporting structures may be at a height prior to the connection of releasable attaching members thereto such that the supporting structures may be received on a vehicle standing upright in the same manner as when in operational use without the risk of such structure contacting other structures (e.g., bridges) during transport. In another example, a bottom end (i.e., the end closer to horizontal portion 381) of such supporting structures could be connectable to a releasable attaching member to facilitate arrangement of such supporting structures and ensure that a height of such arranged supporting structures are of desired height (i.e., below that of a required or desired height relative to bridges on highways or railways. Such releasable attaching members may be connected to a remainder of a leg portion as described above relative to the releasable attachment of an extension portion to the remainder of the side portion.

The above described system (e.g., basin 51) may be used for the temporary short or long term storage of any form of liquid or slurry where in-ground impoundments or frack tanks are either not permitted or not viable. Such systems are intended to be used above ground and are portable; the frame units and separate hardware can be individually stacked and transported by truck to any location including very remote locations. The systems may be easily assembled, broken down and re-assembled at different locations. For example, each of frames 100 or frames 300 may be releasably connected to adjacent frames of frames 100 or frames 300 to form the structure of basin 51 by a plurality of clamps (e.g., clamp 150) and/or other connecting mechanism (e.g., cables) thereby allowing a basin to be constructed in various sizes and shapes (e.g., by using different number of frames 100 or frames 300 in different configurations) and allowing the easy deconstruction and movement of such a basin from one place to another due to the releasable nature of the connections. The frames may also be separated from each other and re-used after a basin has achieved a particular purpose, for example. The assembly and re-assembly may be done by hand with the assistance of lifting machinery. The system (e.g., basin 51) may be used for central frack water storage in the Marcellus shale industry in Pennsylvania where limited access is available, for example. It may also be used for many other types of storage requirements. Basin 51 would not affect the existing water table and has a minimal impact on the ground and surrounding area where it is being used due to its above ground construction.

Further, basin 51 may permit temporary storage of millions of gallons of fresh water used in industrial, commercial and energy applications. Basin 51 may be twelve or more feet high, for example, providing a larger storage capacity when compared to similar above ground systems. The use of a releasable extension portion connectable to a leg portion (e.g., leg portion 340) or support portion (e.g., support portion 330) allows for variable heights of basins (e.g., basin 51) constructed as described above while still allowing easy transport by conventional vehicles (e.g., truck or train). The described systems may be portable and may be assembled, broken down re-located and re-assembled in a minimal time-frame as compared to similar above ground systems as described above.

Basin 51 may be completely modular and can be constructed into any shape or size configuration based on needs (e.g., maximizing the drill pad footprint) of a user. The system described (e.g., basin 51) may have in-floor or thru-wall piping capabilities for quick fill and discharge requirements. The system described (e.g., basin 51) may have minimal labor and equipment requirements for assembly/disassembly. Further, the system described (e.g., basin 51) is environmentally friendly and requires minimal disturbance/impact to terrain.

As described above, the components of basin 51 could further be configured as a cofferdam to divert water such that the water is separated from a dry location where work is desired to be performed.

While the invention has been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. An above ground liquid impoundment or cofferdam system comprising:
a substantially impermeable liner bounding an interior for receiving a liquid;
a plurality of supporting structures and a base supporting the liner and the liquid when the liquid is received in said interior;
said liner extending from said base over a top end of said plurality of supporting structures and descending to the ground to form a cavity under said plurality of supporting structures; and
a first supporting structure of said plurality of supporting structures comprising a leg member supporting said liner and a support member connected to said leg member and holding said leg member upright, at least one of said leg member and said support member comprising a releasably attachable extension portion to allow separation of said extension portion from a remainder of at least one of said leg member and said support member.

2. The system of claim 1 further comprising a bridge received in a cavity of said at least one of said leg member and said support member.

3. The system of claim 1 further comprising a bridge having a cross sectional area dimensioned to allow an end of said bridge to be received in a cavity of said at least one of said leg member and said support member.

4. The system of claim 2 wherein said at least one of said leg member and said support member is releasably attached to said bridge by a temporary weld.

5. The system of claim 1 wherein said extension portion is releasably connected to said remainder by a bridge received in a first cavity of said extension portion and a second cavity of said remainder.

6. The system of claim 2 wherein said at least one of said leg member and said support member is releasably attached to said bridge by a releasable fastening member.

7. The system of claim 6 wherein said releasable fastening member comprises one of a nut, bolt and screw.

8. The system of claim 1 wherein an end of said at least one of said leg member and said support member is received in a cavity of said extension portion.

9. The system of claim 1 wherein said extension portion has a cross sectional area dimensioned to allow an end of said at least one of said leg member and said support member to be received in a cavity of said extension portion.

10. The system of claim 1 further comprising a vehicle and wherein said plurality of supporting structures is arranged on a bed of said vehicle such that a side of said leg member opposite said supporting member contacts said bed while said supporting member extends upwardly away from said bed.

11. The system of claim 10 wherein said leg member and said supporting member extend less than 9 feet 5 inches upwardly away from said bed.

12. A method for use in impounding or diverting a liquid comprising:
transporting a plurality of supporting structures from a first location to a set up location, each supporting structure of said plurality of supporting structures comprising a leg member configured to support a liner and a support member connected to said leg member and configured to hold said leg member upright;
releasably attaching an extension portion of at least one of said leg member and said support member to a remainder of said at least one of said leg member and said support member; and
connecting the plurality of supporting structures to one another such that a base is surrounded by the plurality of supporting structures.

13. The method of claim 12 wherein the releasably attaching comprises receiving a bridge in a cavity of the at least one of said leg member and said support member.

14. The method of claim 13 wherein the releasably attaching comprises attaching the at least one of the leg member and the support member to the bridge by a temporary weld.

15. The method of claim 13 wherein the releasably attaching comprises the attaching at least one of the leg member and the support member to the bridge by a releasable fastening member.

16. The method of claim 15 wherein the releasable fastening member comprises one of a nut, bolt and screw.

17. The method of claim 12 wherein the releasably attaching comprises receiving an end of the at least one of the leg member and the support member in a cavity of the extension portion.

18. The method of claim 12 wherein a side of the leg member opposite the supporting member contacts a bed of a transport vehicle while the supporting member extends upwardly away from the bed.

19. The method of claim 18 wherein the leg member and the supporting member extend less than 9 feet 5 inches upwardly away from the bed.

20. An above ground liquid impoundment or cofferdam system comprising:
a substantially impermeable liner bounding an interior for receiving a liquid;
a plurality of supporting structures supporting the liner and the liquid when the liquid is received in said interior; and
a first supporting structure of said plurality of supporting structures comprising a leg member supporting said liner and a support member connected to said leg member and holding said leg member, at least one of said leg member and said support member comprising a releasably attachable extension portion to allow separation of said extension portion from a remainder of at least one of said leg member and said support member.
